(19) United States
(12) Patent Application Publication
(10) Pub. No.: US 2014/0059692 A1
(43) Pub. Date: Feb. 27, 2014

(54) SYSTEM AND METHOD FOR CROSS DOMAIN FLIGHT DATA IMPORT AND EXPORT

(71) Applicants: Michael Dapp, Endwell, NY (US); Brad E. Schwagler, San Francisco, CA (US); Philip Cowell, Johnson City, NY (US)

(72) Inventors: Michael Dapp, Endwell, NY (US); Brad E. Schwagler, San Francisco, CA (US); Philip Cowell, Johnson City, NY (US)

(21) Appl. No.: 13/591,346

(22) Filed: Aug. 22, 2012

(51) Int. Cl. G06F 21/00

(52) U.S. Cl. 726/26

(57) ABSTRACT

A computer system and method for automated export of classified flight data. The computer system can include a processor and a memory coupled to the processor. The memory can store software instructions that, when executed by the processor, cause the processor to perform operations. The operations can include receiving, in a classified security domain, a request for a dataset to be transmitted to an unclassified transponder device. A first subset and a second subset of the requested dataset can be determined such that the first subset contains classified data and the second subset contains unclassified data. An unclassified version of the first subset can be calculated by redacting non-geographic position (GPS) data and calculating a lower precision GPS value for GPS data. The unclassified version of the first subset can be combined with the unclassified second subset to create a downgraded dataset that can be transmitted to the transponder device.

### CROSS DOMAIN FLIGHT DATA IMPORT AND EXPORT

Embodiments relate generally to automated, real-time, cross domain flight data import and export and, more particularly, to methods and systems for transmitting geographic location data from a classified security domain via an unclassified transponder device.

Aircraft operating within civilian or commercial airspace may be required to provide flight data to air traffic controllers and other aircraft operating within the surrounding airspace. Military aircraft operating within this airspace may also be required to provide flight data to civilian or commercial air traffic controllers and other aircraft operating within the surrounding airspace. For military aircraft operating within civilian or commercial airspace, a need may exist to automate real-time conversion of classified flight data into an unclassified form so that a single classified mission processing system can transmit the unclassified form of the classified flight data to civilian or commercial air traffic controllers via an unclassified transponder.

One embodiment includes a computer system for transmitting data from a classified security domain via an unclassified transponder device. The computer system can include a processor and a memory coupled to the processor. The memory can store software instructions that, when executed by the processor, cause the processor to perform operations. The operations can include receiving, in a classified security domain, a send request specifying a dataset to be transmitted via an unclassified transponder device. A first subset and a second subset of the requested dataset can be determined such that the first subset contains classified data and the second subset contains unclassified data. A first portion and a second portion of the first subset can be determined such that the first portion contains only classified geographic position data and the second portion contains a remainder of other classified data. Low precision geographic position data can be created based on the classified geographic position data of the first portion. The first subset can be transformed into an unclassified form by redacting the second portion and replacing the first portion with the low precision geographic position data. The unclassified form of the first subset can be combined with the second subset to create a downgraded send request. The operations can include transmitting the downgraded send request to the transponder device that can be configured to use the downgraded send request to transmit the low precision geographic position data.

Another embodiment can include a method for transmitting data from a secure data environment via a transponder device. The method can include receiving, in a first security domain, a send request specifying a dataset to be transmitted via a transponder device located within a second security domain that has a lower classification level than the first security domain. Based on the classification level of the second security domain, the method can determine a first subset and a second subset of the requested dataset, the first subset containing data that should be modified before being transmitted to the second security domain and the second subset containing a remainder of data that may be transmitted to the secondary domain without modification. A modified version of the first subset of the requested dataset can be calculated based on the classification level of the second security domain. The method can combine the modified version of the first subset and the second subset to create a downgraded send request and transmit the downgraded send request to the transponder device that is configured to initiate a transmission based on the downgraded send request.

Another embodiment can include a nontransitory computer readable medium having stored thereon software instructions that, when executed by a computer, cause the computer to perform a series of operations. The operations can include receiving, in a first security domain, a send request specifying a dataset to be transmitted to a transponder device located within a second security domain, the second security domain having a lower classification level than the first security domain. The operations can also include, based on the classification level of the second security domain, determining a first subset and a second subset of the requested dataset, the first subset containing data that should be modified before being transmitted to the second security domain and the second subset containing a remainder of data that may be transmitted to the secondary domain without modification. A modified version of the first subset of the requested dataset can be calculated based on the classification level of the second security domain. The operations can include combining the modified version of the first subset and the second subset to create a downgraded send request and transmitting the downgraded send request to the transponder device.

Another embodiment includes a computer system for transmitting data from a classified security domain via an unclassified transponder device. The computer system can include a processor and a memory coupled to the processor. The memory can store software instructions that, when executed by the processor, cause the processor to perform operations. The operations can include receiving, in a first security domain, a send request specifying a dataset to be transmitted to a transponder device located within a second security domain, the second security domain having a lower classification level than the first security domain. The operations can also include, based on the classification level of the second security domain, determining a first subset and a second subset of the requested dataset, the first subset containing data that should be modified before being transmitted to the second security domain and the second subset containing a remainder of data that may be transmitted to the secondary domain without modification. A modified version of the first subset of the requested dataset can be calculated based on the classification level of the second security domain. The operations can include combining the modified version of the first subset and the second subset to create a downgraded send request and transmitting the downgraded send request to the transponder device.

### BRIEF DESCRIPTION OF THE DRAWINGS

FIG. 1 is a block diagram of an exemplary embodiment of a cross domain flight data import/export system.

FIG. 2 is a flowchart showing an exemplary method for extracting unclassified flight data from classified flight data via an unclassified transponder.

FIG. 3 is a block diagram of an exemplary embodiment of a cross domain flight data transmission system.

FIG. 4 is a block diagram of an exemplary embodiment of cross domain flight data transmission system.

FIG. 5 is a flowchart showing an exemplary method for receiving flight data via an unclassified transponder.

### DETAILED DESCRIPTION

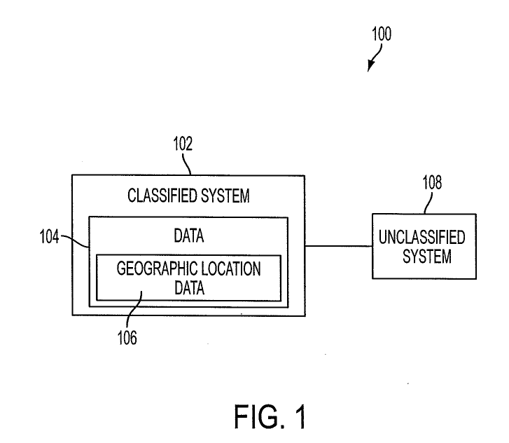

FIG. 1 is a block diagram of an exemplary embodiment of a cross domain flight data import/export system. System 100 can include a classified system 102 that can include data 104. The data 104 can include classified high precision geographic location data 106, such as high precision GPS data. The classified system 102 can transmit data to and receive data from an unclassified system 108.

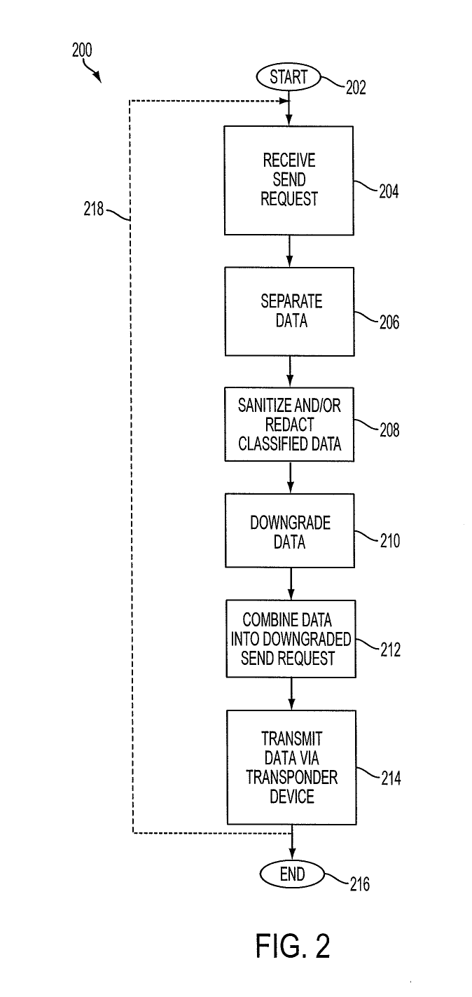

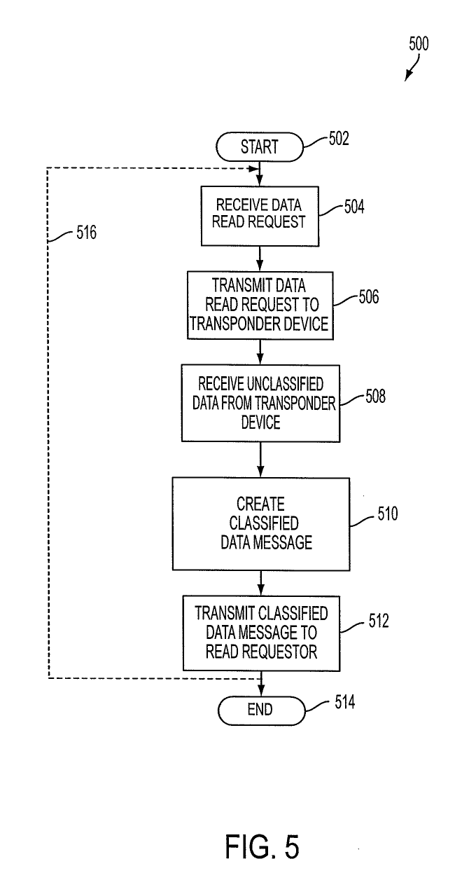

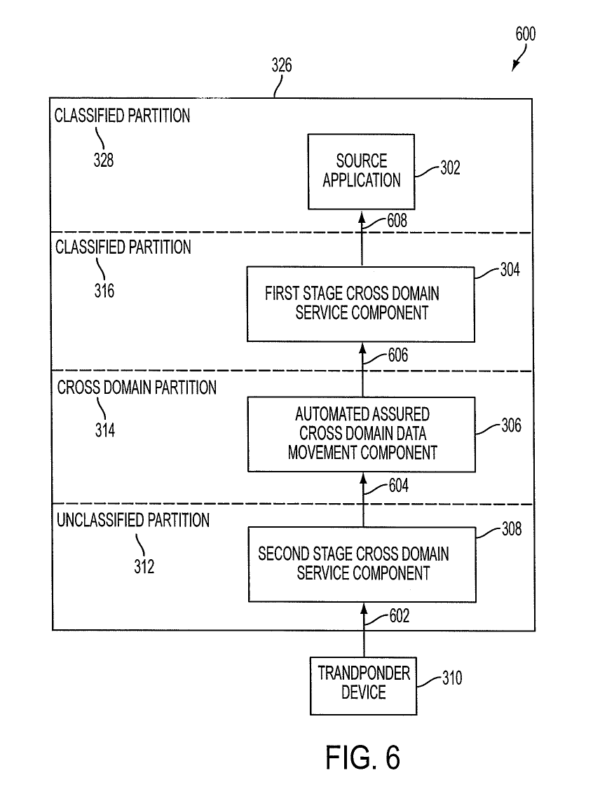

In operation, the classified system 102 can transmit the classified high precision geographic location data 106 to the unclassified system 108 according to the process shown in FIG. 2. The classified system 102 can receive data from the unclassified system 108 according to the process shown in FIG. 5.

It will be appreciated that the unclassified system 108 can include an unclassified transponder device as shown in FIGS. 2 and 5.

The unclassified system 108 can include the following components which are not shown: an Automatic Dependent Surveillance-Broadcast (ADS-B) transponder and an Identification, Friend or Foe (IFF) transponder.

FIG. 2 is a flowchart showing an exemplary method for extracting unclassified flight data from classified flight data via an unclassified transponder 200. Processing begins at 202 and continues to 204.

At 204, a data send request is received within a classified system. The data send request can specify a dataset to be transmitted via a transponder device. The transponder device can be in a security domain having a lower classification level than the security domain in which the data send request or dataset originate. For example, the data send request can be received within a classified domain requesting a dataset be transmitted via a transponder device located in an unclassified domain. Processing continues to 206.

At 206, the requested dataset is separated based on classification level. The data is separated into two subsets: a first subset containing data that should be modified prior to being exported (e.g., classified data) and a second subset containing data that can be exported without modification (e.g., unclassified data). The data classification level can be identified based on a parameter received with the data send request that indicates the data classification level. Classified data can be modified to render the data unclassified by converting the data from high precision to low precision form which it can be then sent to the cross domain down grader. Unclassified data is sent unchanged to the cross domain down grader. Processing continues to 208.

At 208, the first subset is modified so that it may be exported. For example, modification of classified data can be performed by sanitizing the data. Sanitizing can include separating the first subset into a first portion and a second portion. The first portion can contain only geographic position data (e.g. classified high precision GPS data) and the second portion can contain a remainder of other data. Sanitizing can include creating, based on the geographic position data of the first portion, low precision geographic position data having a classification level less than or equal to the classification level of the security domain in which the transponder device resides. Sanitizing can also include redacting the second portion. Redacting can include zeroing out, truncating, populating with random data, or populating with constant/default data. Redacting can also include selective deletion or alteration of data which is classified so that the resulting data is unclassified such as altering classified altitude information to contain redacted unclassified altitude information. Processing continues to 210.

At 210, the second subset and the modified version of the first subset are downgraded to a classification level less than or equal to the classification level of the transponder device. For example, unclassified data originating from a classified domain should be downgraded to unclassified before being exported to an unclassified domain. Downgrading can include verification that the data is unclassified. Downgrading can be performed utilizing a certified guard component that examines the data stream and verifies that the data conforms to a format and value range specified in predetermined downgrading guard control tables. The certified guard component can be separately certified. For example, the data send request received at 204 can assert that a subset of the dataset is releasable without modification and downgrading can include verifying that asserted subset conforms to a format and value range specified in predetermined downgrading guard control tables before the asserted dataset is downgraded and/or exported and/or released without modification. Also, for example, downgrading can include verifying that the sanitized and/or redacted data from 208 conforms to a format and value range specified in predetermined downgrading guard control tables before the asserted dataset is downgraded and/or exported and/or released without modification. This downgrading and/or verification can, for example, be performed by a certified guard component that can be implemented in hardware and/or software. For example, the certified guard component can be one or more certified products such as, but not limited to, Lockheed Martin Radiant Mercury and/or Lockheed Martin Trusted Manager (TMAN). Processing continues to 212.

At 212, the downgraded modified version of the first subset (e.g., sanitized data) and the downgraded second subset (e.g., unclassified data) are combined into a downgraded dataset and incorporated into a downgraded send request. The downgraded send request can be an unclassified message that can be in the form of an ADS-B or IFF send request or any other format used for requesting data to be transmitted by a transponder device. Processing continues to 214.

At 214, the downgraded send request is transmitted to a transponder device, causing the transponder device to transmit the downgraded dataset. Processing continues to 216, where processing ends.

It will be appreciated that operations 204-214 may be repeated in whole or in part (an example of which is indicated by line 218) to maintain current (regularly or continuously updated) data transmissions.

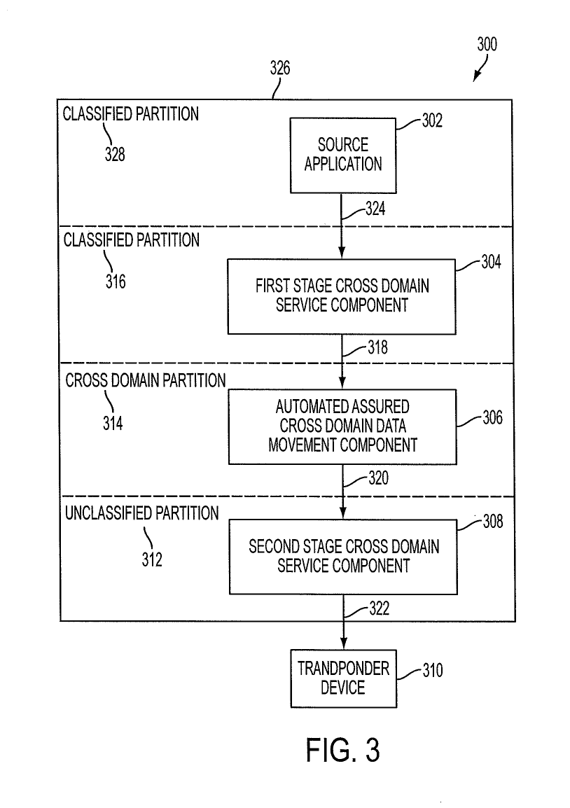

FIG. 3 is a block diagram of an exemplary embodiment of a cross domain flight data transmission system. System 300 can include a source application 302 that can transmit a data send request to a first stage cross domain service component 304. The first stage cross domain service component 304 can transmit santized and unclassified portions of the requested data to an automated assured cross domain data movement component 306. The automated assured cross domain data movement component 306 can transmit downgraded unclassified data and downgraded sanitized data to a second stage cross domain service component 308. The second stage cross domain service component 308 can transmit an unclassified send request to a transponder device 310.

The system 300 can be divided into security domains or secure partitions based on classification level. The source application 302 can be located within a classified partition 328. The first stage cross domain service component 304 can be located within a classified partition 316. The automated assured cross domain data movement component 306 can be located within a cross domain partition 314, and the second stage cross domain service component 308 can be located within an unclassified partition 312.

Data flow can be prevented across partitions except for explicitly allowed channels. Classified data can be explicitly allowed to flow through a channel 324 from the source application 302 located within the classified partition 328 to the first stage cross domain service component 304 located within the classified partition 316. A client-server protocol can be used to transfer a classified plain text payload across channel 324. Data can be explicitly allowed to flow through a channel 318 from the first stage cross domain service component 304 located in the classified partition 316 to the automated assured cross domain data movement component 306 located within the cross domain partition 314. A client-server protocol can be used to transfer an unclassified plain text payload across channel 318. Unclassified data can be explicitly allowed to flow through a channel 320 from the automated assured cross domain data movement component 306 to the second stage cross domain service component 308 located within the unclassified partition 312. A client-server protocol can be used to transfer an unclassified plain text payload across channel 320. The unclassified partition 312 can be explicitly granted access to various hardware interfaces through a channel 322, including a transponder device 310 that can accessed via an optional local area network (LAN) not shown. A plain text transponder protocol can be used to transfer a plain text payload across channel 322.

It will be appreciated that the secure partitions (312, 314, 316, and 328) can be located on the same or on different computers. When run on the same computer, a multiple independent levels of security (MILS) separation kernel and a guest real-time operating system (RTOS) can be used to create the necessary partitions and prevent data flow across the partitions except for the explicitly allowed channels (324, 318, 320, and 322) described above. Partitions 328, 316, and 312 can include a guest RTOS that is POSIX compliant and includes virtual CSP/BSP board support package drivers. The cross domain partition 314 can include a minimal runtime Evaluation Assurance Level (EAL) 6+ certified RTOS. All four partitions (312, 314, 316, and 328) can include a common open standards application programming interface (API) layer.

In operation, the source application 302 can transmit a data send request to the first stage cross domain service component 304. The send request can contain or reference classified and/or unclassified data. The source application 302 can initiate the data send request using a client-server method invocation on the first stage cross domain service component 304. The first state cross domain service component 304 can include a server waiting for connections from the client source application 302. The send request can specify a transponder device located in a security domain or secure partition having a lower classification level than the security domain or secure partition from which the send request or data originates.

The first stage cross domain service component 304 can separate the requested data into two subsets based on classification level. The first subset can contain data having a classification level that is higher than the security domain in which the transponder device is located. The second subset can contain data having a classification level less than or equal to the classification of the security domain in which the transponder device is located. The first subset can be sanitized according to the process shown in FIG. 2 to allow for export to a security domain having a lower classification level. The sanitized first subset and the second subset can be transmitted to the automated assured cross domain data movement component 306 located in the cross domain partition 314 through the explicitly allowed channel 318.

The automated assured cross domain data movement component 306 can downgrade the sanitized first subset and the second subset. The downgraded sanitized first subset and the downgraded second subset can be transmitted from the automated assured cross domain data movement component 306 to the second stage cross domain service component 308 located in the unclassified partition 312 through the explicitly allowed channel 320.

The second stage cross domain service component 308 can combine the downgraded sanitized first subset and the downgraded second subset into an unclassified or downgraded send request and transmit the downgraded send request via a transponder device 310. The downgraded send request may be in the form of an ADS-B or IFF send request or any other format used for transmitting data via a transponder device, whether the transponder device is accessed locally or remotely.

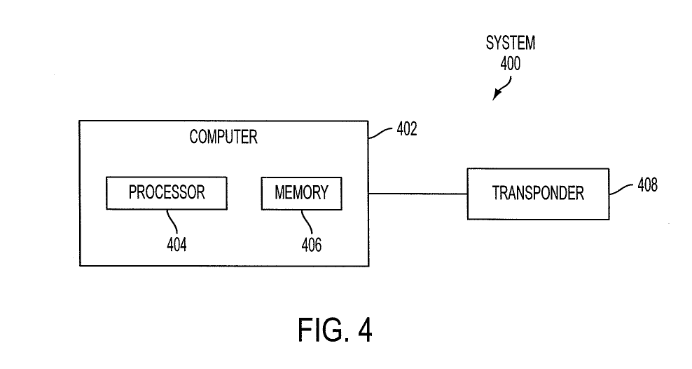

FIG. 4 is a block diagram of an exemplary embodiment of cross domain flight data transmission system. System 400 can include a computer 402 that can include a processor 404 and a memory 406. The computer 402 can transmit data to and/or receive data from a transponder device 408.

In operation, the processor 404 will execute instructions stored on the memory 406 that cause the computer 402 to transmit data to and/or receive data from the transponder device 408 according to the processes shown in FIGS. 2 and 5.

It will be appreciated that the transponder device 408 may be attached to the system using any transponder connection type now known or later developed.

The transponder device 408 can include the following components which are not shown: an Automatic Dependent Surveillance-Broadcast (ADS-B) transponder and an Identification, Friend or Foe (IFF) transponder.

FIG. 5 is a flowchart showing an exemplary method for receiving flight data via an unclassified transponder 500. Processing begins at 502 and continues to 504.

At 504, a data read request is received within a classified system. The data read request can specify a type of data to be read by a transponder device. For example, the data read request can specify that the transponder is to read ADS-B and/or IFF type data. The transponder device can be in a security domain having a lower classification level than the security domain in which the read request originates. For example, the data read request can be received within a classified security domain or partition requesting data to be read by a transponder device located in an unclassified domain or partition. Processing continues to 506.

At 506, the read request is transmitted to the transponder device. The read request can be transmitted from a classified partition to an unclassified partition through the use of a cross domain partition described in FIGS. 3 and 6. The read request can be in the form of an ADS-B or IFF read request or any other format used for reading data from a transponder device. Processing continues to 508.

At 508, a response from the transponder device containing the data read is received. Processing continues to 510.

At 510, a classified data message is created containing the contents of the data received from the transponder device. Processing continues to 512.

At 512, the classified data message is transmitted to the read requestor. The read requestor can reside within a classified security domain. Processing continues to 514, where processing ends.

It will be appreciated that operations 504-512 may be repeated in whole or in part (an example of which is indicated by line 516) to maintain current (regularly or continuously updated) data imports.

FIG. 6 is a block diagram of an exemplary cross domain flight data transmission system. System 600 can include elements similar to those described in FIG. 3, and those elements have been given reference numerals to corresponding to the elements described in FIG. 3.

As described above in FIG. 3, data flow can be prevented across partitions except for explicitly allowed channels. Unclassified data can be explicitly allowed to flow through a channel 602 from the transponder device 310 to the second state cross domain service component 308 located within the unclassified partition 312 of the classified system 326. A plain text transponder protocol can be used to transfer a plain text payload across channel 602. The transponder device 310 can be connected to the classified system 326 via an optional local area network (LAN) not shown. Data can be explicitly allowed to flow through a channel 604 from the second stage remote storage service component 308 located in the unclassified partition 312 to the automated assured cross domain data movement component 306 located within the cross domain partition 314. A client-server protocol can be used to transfer an unclassified plain text payload across channel 604. Unclassified data can be explicitly allowed to flow through a channel 606 from the automated assured cross domain data movement component 306 to the first stage cross domain service component 304 located within the classified partition 316. A client-server protocol can be used to transfer an unclassified plain text payload across channel 606. Classified data can be explicitly allowed to flow through a channel 608 from the first stage cross domain service component 304 located within the unclassified partition 316 to the source application 302 located within the classified partition 330. A client-server protocol can be used to transfer a classified plain text payload across channel 608. The first stage cross domain service component 304 can combine additional classified data with the unclassified plain text payload received from the automated assured cross domain data movement component 306 via channel 606, and transmit the combined data to the source application 302 via channel 608.

It will be appreciated that the modules, processes, systems, and sections described above can be implemented in hardware, hardware programmed by software, software instructions stored on a nontransitory computer readable medium or a combination of the above. A system for cross domain flight data import and export, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or transponder device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the computer programming and network security arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for cross domain flight data import and export.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A computer system for transmitting data from a classified security domain via an unclassified transponder device, said computer system comprising:
a processor; and
a memory coupled to the processor, the memory having stored therein software instructions that, when executed by the processor, cause the processor to perform operations including:
receiving a send request, in a classified security domain, the send request specifying a dataset to be transmitted via an unclassified transponder device;
determining a first subset and a second subset of the dataset, the first subset containing classified data and the second subset containing only unclassified data;
determining a first portion and a second portion of the first subset, the first portion containing only classified geographic position data and the second portion containing other classified data;
creating low precision geographic position data based on the classified geographic position data of the first portion;
transforming the first subset into an unclassified form, the transformation including redacting the second portion and replacing the first portion with the low precision geographic position data;
downgrading the unclassified form of the first subset and the second subset;
combining the second subset and the unclassified form of the first subset to create a downgraded send request; and
transmitting the downgraded send request to the unclassified transponder device, wherein the transponder device is configured to use the downgraded send request to transmit the low precision geographic position data.

2. The system of claim 1, wherein the unclassified transponder device includes:
an Automatic Dependent Surveillance-Broadcast (ADS-B) transponder; and
an Identification, Friend or Foe (IFF) transponder.

3. The system of claim 1, wherein said computer system has a Multiple Independent Levels of Security (MILS) architecture and is partitioned into a plurality of partitions, said plurality of partitions including at least a classified partition, a cross domain partition, and an unclassified partition, and separation of said plurality of partitions is maintained by said architecture.

4. The system of claim 3, wherein
said send request specifying a dataset to be transmitted via an unclassified transponder device is received in said classified partition,
said second subset and the unclassified form of the first subset are transmitted from said classified partition to a cross domain partition,
said downgraded send request is transmitted from said cross domain partition to said unclassified partition if downgrading is permitted,
said downgraded send request is transmitted from said unclassified partition to said unclassified transponder device.

5. A method for transmitting data from a secure data environment via a transponder device, the method comprising:
receiving, in a first security domain, a send request, the send request specifying a dataset to be transmitted via a transponder device located within a second security domain, the second security domain having a lower classification level than the first security domain;
based on the classification level of the second security domain, determining a first subset and a second subset of the requested dataset, the first subset containing data to be modified before being transmitted to the second security domain and the second subset containing a remainder of data to be transmitted to the secondary domain without modification;
creating a modified version of the first subset, based on the classification level of the second security domain;
downgrading the modified version of the first subset and the second subset;
combining, if downgrading is permitted, the modified version of the first subset and the second subset to create a downgraded send request; and
transmitting the downgraded send request to the transponder device, wherein the transponder device is configured to initiate a transmission based on the downgraded send request.

6. The method of claim 5, wherein the first security domain is classified secret and the second security domain is unclassified.

7. The method of claim 5, wherein the first security domain is classified top secret and the second security domain is unclassified.

8. The method of claim 5, wherein the first security domain is classified top secret and the second security domain is classified secret.

9. The method of claim 5, wherein creating the modified version of the first subset includes:
determining a first portion and a second portion of the first subset, the first portion containing only geographic position data and the second portion containing other data;
creating low precision geographic position data based on the geographic position data of the first portion; and
transforming the first subset into a downgraded form having a classification level less than or equal to the classification level of the second security domain, the transformation including replacing the first portion with the low precision geographic position data and redacting the second portion.

10. The method of claim 5, wherein the transponder device includes:
an Automatic Dependent Surveillance-Broadcast (ADS-B) transponder; and
an Identification, Friend or Foe (IFF) transponder.

11. The method of claim 5, wherein said computer system has a Multiple Independent Levels of Security (MILS) architecture and is partitioned into a plurality of partitions, said plurality of partitions including at least a classified partition, a cross domain partition, and an unclassified partition, and separation of said plurality of partitions is maintained by said architecture.

12. The method of claim 5, wherein
said send request specifying a dataset to be transmitted via an unclassified transponder device is received in said classified partition,
said second subset and the modified version of the first subset are transmitted from said classified partition to a cross domain partition,
said downgraded send request is transmitted from said cross domain partition to said unclassified partition if downgrading is permitted,
said downgraded send request is transmitted from said unclassified partition to said unclassified transponder device.

13. A nontransitory computer readable medium having stored thereon software instructions that, when executed by a computer, cause the computer to perform operations comprising:
receiving, in a first security domain, a send request, the send request requesting a dataset to be transmitted via a transponder device located within a second security domain, the second security domain having a lower classification level than the first security domain;
based on the classification level of the second security domain, determining a first subset and a second subset of the requested dataset, the first subset containing data to be modified before being transmitted to the second security domain and the second subset containing the remainder of data to be transmitted to the secondary domain without modification;
creating a modified version of the first subset, based on the classification level of the second security domain;
downgrading the modified version of the first subset and the second subset;
combining, if downgrading is permitted, the modified version of the first subset and the second subset to create a downgraded send request; and
transmitting the downgraded send request to the transponder device.

14. The computer program product of claim 13, wherein the first security domain is classified secret and the second security domain is unclassified.

15. The computer program product of claim 13, wherein the first security domain is classified top secret and the second security domain is unclassified.

16. The computer program product of claim 13, wherein the first security domain is classified top secret and the second security domain is classified secret.

17. The computer program product of claim 13, wherein creating the modified version of the first subset includes:
determining a first portion and a second portion of the first subset, the first portion containing only geographic position data and the second portion containing other data;
redacting the second portion;
creating low precision geographic position data based on the geographic position data of the first portion; and
replacing the first portion with the low precision geographic position data.

18. The computer program product of claim 13, wherein the transponder device includes:
an Automatic Dependent Surveillance-Broadcast (ADS-B) transponder; and
an Identification, Friend or Foe (IFF) transponder.

19. The computer program product of claim 13, wherein said computer system has a Multiple Independent Levels of Security (MILS) architecture and is partitioned into a plurality of partitions, said plurality of partitions including at least a classified partition, a cross domain partition, and an unclassified partition, and separation of said plurality of partitions is maintained by said architecture.

20. The computer program product of claim 13, wherein
said send request specifying a dataset to be transmitted via an unclassified transponder device is received in said classified partition,
said second subset and the modified version of the first subset are transmitted from said classified partition to a cross domain partition,
said downgraded send request is transmitted from said cross domain partition to said unclassified partition if downgrading is permitted,
said downgraded send request is transmitted from said unclassified partition to said unclassified transponder device.
